(19) United States
(12) Patent Application Publication
(10) Pub. No.: US 2014/0263288 A1
(43) Pub. Date: Sep. 18, 2014

(54) MAGNETIC INDUCTION FEEDBACK MECHANISM FOR A HEATING SYSTEM AND THE METHOD USING THE SAME

(71) Applicant: Ming-Chang Huang, Taoyuan County (TW)

(72) Inventor: Ming-Chang Huang, Taoyuan County (TW)

(21) Appl. No.: 13/845,148

(22) Filed: Mar. 18, 2013

(51) Int. Cl. H05B 6/06

(52) U.S. Cl. CPC H05B 6/06
USPC 219/660

(57) ABSTRACT

A heating system for heating a magnetic inducible container is disclosed, wherein the heating system includes a frequency detector for detecting the frequency of the current through an inductor coil and a control unit coupled to the frequency detector to adjust the heat generated by the heating system according to the variation of the frequencies detected by the frequency detector.

### BACKGROUND OF THE INVENTION

I. Field of the Invention

The present invention relates to a power control mechanism and, more particularly, to the power control in a heating system.

II. Description of the Prior Art

Heating system is very important in daily life. Conventional induction cooker or other cookers are used to heat foods and water. But, in certain situation, it may cause unnecessary power consumption if people do not pay attention to it while cooking. For instance, as the water in a container reaches its boiling point, the temperature of the water will not be risen up without limitation and, on the contrary, it will output energies back to the cooker, which will cause more of steaming exhausted to the air and increase power consumption.

It is well know that a temperature sensor can be used to measure the temperature; however, the temperature sensor must be close to the container in order to measure the temperature correctly. Therefore, a temperature sensor is not convenient for controlling the temperature of the container cooked by a cooker.

Therefore, what is needed is a heating system that can reduce the power consumption and control the temperature of the container efficiently.

### SUMMARY OF THE INVENTION

One object of this invention is to provide a methodology for controlling the power of a heating system by detecting variations of frequencies in an inductor coil in the heating system.

One embodiment discloses a heating system for heating a magnetic inducible container, wherein the heating system comprises: a first circuit comprising an inductor coil, wherein the magnetic inducible container is over the inductor coil; a power supply for supplying a current to the inductor coil of the first circuit; a frequency detector, for detecting the frequency of the current through the inductor coil; a control unit coupled to the frequency detector, wherein the control unit adjust the current flowing through the inductor coil according to the variation of the frequencies detected by the frequency detector.

In one embodiment, the heating system is an induction cooker, wherein magnetic inducible container is heated through the inductor coil. As shown in FIG. 1, an induction cooker contains a coil which generates electromagnetic wave to energize a container sitting over the coil, when the coil is conducting a current which is supplied by a power supply. The current flowing through the coil has a frequency determined by the inductance of the coil and the capacitance of the capacitor. However, the mutual inductance resulted from the interaction between the coil and the container will also affect the frequency of the current flowing through the coil.

In one embodiment, the heating system is a gas strove, wherein a gas strove comprises a gas escape vent through a valve for heating. In one embodiment, the heating system is an electric heater, wherein the electric heater comprises a thermal resistor for heating.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a block diagram of a heating system according to current invention

FIG. 2A-2D illustrates schematics of an induction cooker according to one embodiment of the current invention.

FIG. 3 illustrates a block diagram of a gas strove according to one embodiment of the current invention.

FIG. 4A-4C schematics of a gas strove according to one embodiment of the current invention.

FIG. 5 illustrates a block diagram of an electric heater according to one embodiment of the current invention.

FIG. 6 illustrates pictures of showing the variation of the frequency of the current flowing through the inductor coil.

FIG. 7 illustrates a flowchart of controlling a heating system according to current invention.

### DETAILED DESCRIPTION OF THE INVENTION

The detailed explanation of the present invention is described as following. The described preferred embodiments are presented for purposes of illustrations and description, and they are not intended to limit the scope of the present invention.

FIG. 1 illustrates a heating system for heating a magnetic inducible container, wherein the heating system 100 comprises: a first circuit 102 comprising an inductor coil, wherein the magnetic inducible container 101 is over the inductor coil; a power supply 105 for supplying a current to the inductor coil of the first circuit 102; a frequency detector 104, for detecting the frequency of the current through the inductor coil; a control unit 103 coupled to the frequency detector, wherein the control unit 103 adjusts the current flowing through the inductor coil according to the variation of the frequencies detected by the frequency detector 104. In one embodiment, for example, the control unit 103 can decrease the power output to the magnetic inducible container 101 when the water in the magnetic inducible container 101 has reached its boiling point, which can be detected by a higher frequency of the current flowing through the inductor coil. Later on the control unit 103 can increase the power output to the magnetic inducible container 101 when the frequency of the current flowing through the inductor coil becomes lower for a while. In one embodiment, the magnetic inducible container 101 is an iron bowl. In one embodiment, the heating system 100 is an induction cooker, wherein magnetic inducible container 101 is heated through the inductor coil. In one embodiment, the heating system is a gas strove, wherein a gas strove comprises a gas escape vent through a valve for heating.

In one embodiment, the heating system is an induction cooker, wherein magnetic inducible container is heated through the inductor coil. As shown in FIG. 2A, an induction cooker 200 contains a coil 202 which generates electromagnetic wave to energize a magnetic inducible container 201 sitting over the coil 202, when the coil 202 is conducting a current supplied by a power supply 204. The current flowing through the coil 202 has a frequency determined by the inductance of the coil 202 and the capacitance of the capacitor 203. There are some resistors 205, 206 in the current loop for generating a potential difference across the switch element 214. The switch element will operate with the voltage oscillation of circuit for operating the control gate 207 (Insulated-gate bipolar transistor) to limit the current flowing through the coil 202.

However, the mutual inductance resulted from the interaction between the coil 202 and the magnetic inducible container 201 will also affect the frequency of the current flowing through the coil 202. Furthermore, it is observed, in current invention, that the mutual inductance will change when the temperature of the water in the magnetic inducible container 201 reaches a boiling point of water in the magnetic inducible container 201, thereby the frequency of the current flowing through the coil 202 will change as well. In one embodiment, when the water is boiling, the frequency of the current flowing through the coil 202 will rise up from a normal frequency to a higher frequency, as shown in FIG. 6. In FIG. 6, in normal state, the period of the current signal is 5.5 (2× millisecond), and the period is cut shorter and becomes 5.3 (2× millisecond) when the water in the magnetic inducible container 201 is boiled. The induction cooker 200 includes a frequency detector 208 to convert the frequency of the current flowing through the coil 202 into a voltage 212 which is connected to a comparator 211 to compare with a reference voltage 213 set by a variable resistor 210 and a reference power supply with a voltage V 209. When the converted voltage 212 is grater than the reference voltage 213, the output of the comparator 215 will increase the resistance of resister 216 to decrease the current flowing through the coil 202 so that the power output to the magnetic inducible container 201 can be reduced. Alternatively, a timer can be used to detect the frequency of the current flowing through the coil 202. The timer will set a time interval, periodically, in which the frequency of the current through the inductor coil 202 is measured. In one embodiment, the CPU can measure the frequency without using the hardware converter to convert the frequency to a voltage. For example, a counter can be used to count the frequency periodically and the CPU can read the counter to determine if the frequency has reached a threshold for controlling the heating system. The CPU can also measure the period between two pulses through software as well. In one embodiment, the heating system is an induction cooker, wherein magnetic inducible container is heated through the inductor coil. As shown in FIG. 2B, an induction cooker 200 contains a coil 202 which generates electromagnetic wave to energize a magnetic inducible container 201 sitting over the coil 202, when the coil 202 is conducting a current supplied by a power supply 204. The current flowing through the coil 202 has a frequency determined by the inductance of the coil 202 and the capacitance of the capacitor 203. There are some resistors 205, 206 in the current loop for generating a potential difference across the switch element 214. The switch element will operate with the voltage oscillation of circuit for operating the control gate 207 (Insulated-gate bipolar transistor) to limit the current flowing through the coil 202.

However, the mutual inductance resulted from the interaction between the coil 202 and the magnetic inducible container 201 will also affect the frequency of the current flowing through the coil 202. Furthermore, it is observed, in current invention, that the mutual inductance will change when the temperature of the water in the magnetic inducible container 201 reaches a boiling point of water in the magnetic inducible container 201, thereby the frequency of the current flowing through the coil 202 will change as well. In one embodiment, when the water is boiling, the frequency of the current flowing through the coil 202 will rise up from a normal frequency to a higher frequency, as shown in FIG. 6. In FIG. 6, in normal state, the period of the current signal is 5.5 (2× millisecond), and the period is cut shorter and becomes 5.3 (2× millisecond) when the water in the magnetic inducible container 201 is boiled. The induction cooker 200 includes a frequency detector 208 to convert the frequency of the current flowing through the coil 202 into a voltage 212 which is connected to a comparator 211 to compare with a reference voltage 213 set by a variable resistor 210 and a reference power supply with a voltage V 209. When the converted voltage 212 is grater than the reference voltage 213, the output of the comparator 215 will turn off the control gate 216 to cut off the current flowing through the coil 202 so that the magnetic inducible container 201 can be cooled down. Alternatively, a timer can be used to detect the frequency of the current flowing through the coil 202. The timer will set a time interval, periodically, in which the frequency of the current through the inductor coil 202 is measured. In one embodiment, the CPU can measure the frequency without using the hardware converter to convert the frequency to a voltage. For example, a counter can be used to count the frequency periodically and the CPU can read the counter to determine if the frequency has reached a threshold for controlling the heating system. The CPU can also measure the period between two pulses through software as well. In one embodiment, only the control gate 207 is needed and all the controls to the control gate 216 can be merged with the controls of the control gate 207 through a merged circuit.

As shown in FIG. 2C, a CPU 221 can be used to control the heating system. The CPU 221 takes the converted voltage 212 and the reference voltage 213 in and turn off the control gate 216 to cut off the current flowing through the coil 202 when the converted voltage 212 is grater than the reference voltage 213. As shown in FIG. 2D, a PWM (Pulse Width Modulation) generator 222 can be used to control the gate so that the average current flowing through the coil 202 can be controlled in a more flexible way. In another embodiment, the power supply voltage can be adjusted to a low voltage to reduce the power output to the magnetic inducible container 201.

In one embodiment, the heating system is a gas strove. FIG. 3 illustrates a heating system 300 for heating a magnetic inducible container 301, wherein the heating system 300 comprises: a gas escape vent 219 to control the gas flowing through a valve 229 for heating the magnetic inducible container 301; a first circuit comprising an inductor coil 302, wherein the magnetic inducible container 301 is over the inductor coil 302; a power supply 305 for supplying a current to the inductor coil of the first circuit 302; a frequency detector 304, for detecting the frequency of the current through the inductor coil 302; a control unit 303 coupled to the frequency detector, wherein the control unit 303 adjusts the gas escape vent 219 to control the gas flowing through the valve 229 according to the variation of the frequencies detected by the frequency detector 304. In one embodiment, the magnetic inducible container 101 is an iron bowl.

As shown in FIG. 4A, an gas strove 200 contains a coil 202 which generates electromagnetic wave to energize a magnetic inducible container 201 sitting over the coil 202, when the coil 202 is conducting a current supplied by a power supply 204. The current flowing through the coil 202 has a frequency determined by the inductance of the coil 202 and the capacitance of the capacitor 203. There are some resistors 205, 206 in the current loop for generating a potential difference across the switch element 214. The switch element will operate with the voltage oscillation of circuit for operating the control gate 207 (Insulated-gate bipolar transistor) to limit the current flowing through the coil. However, the mutual inductance resulted from the interaction between the coil 202 and the magnetic inducible container 201 will also affect the frequency of the current flowing through the coil 202. Furthermore, it is observed, in current invention, that the mutual inductance will change when the temperature of the water in the magnetic inducible container 201 reaches a boiling point of water in the magnetic inducible container 201, thereby the frequency of the current flowing through the coil 202 will change as well. In one embodiment, when the water is boiling, the frequency of the current flowing through the coil 202 will rise up from 90.9 Hz to 94.34 Hz.

As shown in FIG. 6, the period of the current signal in normal state is 5.5×2 ms (2 ms is the time unit of FIG. 6) which is 11 ms; therefore the frequency in normal state is 90.9 Hz. When the water has reached its boiling point, the period of the current signal will be changed to 5.3×2 ms which is 10.6 ms. Therefore, the frequency is increased to 94.34 Hz when the water is boiling.

The induction cooker 200 includes a frequency detector 208 to convert the frequency of the current flowing through the coil 202 into a voltage 212 which is connected to a comparator 211 to compare with a reference voltage 213 set by a variable resistor 210 and a reference power supply with a voltage V 209. When the converted voltage 212 is grater than the reference voltage 213, the output of the comparator 214 will turn off the gas escape vent 219 to cut off the gas flowing through the valve 229 so that the power output to the magnetic inducible container 201 can be reduced. As shown in FIG. 4B, a CPU 221 can be used to control the gas strove. The CPU 221 takes the converted voltage 212 and the reference voltage 213 in and cut off the gas flowing through the valve 229 so that the power output to the magnetic inducible container 201 can be reduced when the converted voltage 212 is grater than the reference voltage 213. As shown in FIG. 4C, a PWM (Pulse Width Modulation) generator 222 can be used to control the gas escape vent 219 so that the average amount of gas flowing through the valve 229 can change gradually.

In one embodiment, the heating system is a thermal coupler. FIG. 5 illustrates a electric heater 500 for heating a magnetic inducible container 301, wherein the electric heater 500 comprises: a thermal resistor 506 to heat up the magnetic inducible container 301; a first circuit comprising an inductor coil 302, wherein the magnetic inducible container 301 is over the inductor coil 302; a power supply 305 for supplying a current to the inductor coil of the first circuit 302; a frequency detector 304, for detecting the frequency of the current through the inductor coil 302; a control unit 303 coupled to the frequency detector, wherein the control unit 303 adjusts the thermal resistor to reduce the power output to the magnetic inducible container 301 according to the variation of the frequencies detected by the frequency detector 304. In one embodiment, the magnetic inducible container 101 is an iron bowl.

FIG. 7 illustrates a flowchart 700 of controlling a heating system according to current invention. In step 701, a reference frequency is provided; in step 702, detect the frequency of the current flowing through the coil; and in step 703, adjust the heat according to the detected frequency and the reference frequency.

Please note that the heating system and the method of controlling a heat system can be applied to many other heating systems because the coil used to detect the temperature of a magnetic inducible container can be independent of the heat source of the heating system. In addition, the detecting method of current invention is more feasible than conventional ways because the coil is not touching the container for detecting the boiling point of the water in the container. In summary, the heating system and the method of controlling a heat system of current invention can be applied to other heating system, such as an induction cooker, a gas strove, a thermal heater, a chamber, and so on.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended

What is claimed is:

1. A heating system for heating a magnetic inducible container, comprising:
a first circuit comprising an inductor coil, wherein the magnetic inducible container is coupled to the inductor coil;
a power supply for supplying a current to the inductor coil of the first circuit;
a frequency detector, for detecting the frequency of the current through the inductor coil; and
a control unit coupled to the frequency detector, wherein the control unit adjusts the current flowing through the inductor coil according to the variation of the frequencies detected by the frequency detector, wherein the magnetic inducible container is not removed from the heating system.

2. The heating system according to claim 1, wherein the magnetic inducible container is an iron bowl.

3. The heating system according to claim 1, wherein the heating system is an induction cooker, wherein magnetic inducible container is heated through the inductor coil.

4. The heating system according to claim 1, wherein the heating system is a gas strove, wherein a gas strove comprises a gas escape vent through a valve for heating.

5. The heating system according to claim 1, wherein the heating system is an electric heater, wherein the thermal couple comprises a thermal resistor for heating.

6. The heating system according to claim 1, wherein the frequency detector comprises a timer to set a time period in which the frequency of the current through the inductor coil is measured.

7. The heating system according to claim 1, wherein the frequency detector comprises a convertor to convert the frequency of the current flowing through the coil into a first voltage.

8. The heating system according to claim 7, wherein the frequency detector comprises a variable resistor for setting up a second voltage, wherein the first voltage and the second voltage are inputted to the control unit for controlling the heating system.

9. The heating system according to claim 1, wherein the control unit comprises a pulse width modulator for generating the current to the inductor coil of the first circuit.

10. A method of heating a magnetic inducible container, wherein the magnetic inducible container is coupled to a coil of a heating system, comprising:
providing a reference frequency;
detecting the frequency of the current flowing through the coil; and
adjusting the heat to the magnetic inducible container according to the detected frequency and the reference frequency, wherein the magnetic inducible container is not removed from the heating system.
